(19) United States
(12) Patent Application Publication
(10) Pub. No.: US 2025/0005357 A1
(43) Pub. Date: Jan. 2, 2025

(54) METHOD AND APPARATUS FOR LEARNNING LANGUAGE MODEL FROM STYLISTIC POINT OF VIEW, AND RECORDING MEDIUM FOR RECORDING THE SAME

(71) Applicant: Research & Business Foundation Sungkyunkwan University, Suwon-si (KR)

(72) Inventors: Jungahn YANG, Suwon-si (KR); Jimin AN, Suwon-si (KR); Jee-Hyong LEE, Suwon-si (KR)

(73) Assignee: Research & Business Foundation Sungkyunkwan University, Suwon-si (KR)

(21) Appl. No.: 18/757,832

(22) Filed: Jun. 28, 2024

(30) Foreign Application Priority Data
Jun. 29, 2023 (KR) 10-2023-0084078

(51) Int. Cl. G06N 3/08

(52) U.S. Cl. CPC G06N 3/08

(57) ABSTRACT

Disclosed is a method of training a language model from a stylistic perspective, and the method includes: a first step of pre-training a language model using an unsupervised training method using a first training dataset; a second step of re-training the pre-trained language model using a second training dataset with distinguished styles; and a third step of fine-tuning the re-trained language model using a third training dataset classified by domain through supervised learning.

### CROSS REFERENCE TO RELATED APPLICATION

This application claims priority from Republic of Korea Patent Application No. 10-2023-0084078, filed on Jun. 29, 2023, which is hereby incorporated by reference in its entirety.

### BACKGROUND

### Field

The present disclosure relates to a method and apparatus for training a language model to improve performance of the language model in machine reading comprehension by training the language model in consideration of linguistic characteristics of the Korean language, which is verb-centered, and to a recording medium for recording the same.

### Related Art

Machine Reading Comprehension (MRC) refers to a technology where an artificial intelligence (AI) algorithm independently analyzes a problem and finds an optimized answer to a question. General methods for training a language model for the machine reading comprehension include a process of pre-training a language model using a large corpus through unsupervised learning and then training the language model using a dataset classified by domain through supervised learning.

However, labeled data used for fine-tuning a pre-trained language model require a significant amount of time and cost for labeling. If a task is domain-specific, it is more difficult to obtain the data.

In addition, unlike English, which is a noun-centered language, verb-centered languages such as Korean uses special honorific vocabulary, sentence-ending particles, and auxiliary words that clearly reflect social relationships. Due to these characteristics, styles of Korean are distinguished based on a system of sentence-ending particles, rather than merely on levels of formality. Therefore, adaptive pre-training of a Korean language model requires research from a stylistic perspective.

### SUMMARY

The present disclosure has been conceived under the above technical background, aiming to improve performance of a language model by applying style-based adaptive pre-training, taking into account unique linguistic characteristics of verb-centered languages such as Korean, which differ from those of English.

A training method according to an embodiment of the present disclosure proceeds through three steps to perform style-based adaptive pre-training. As shown in FIG. 1, the training method according to an embodiment of the present disclosure may include: a first step of pre-training a language model through unsupervised learning using a first training dataset; a second step of re-training the pre-trained language model using a second training dataset with distinguished styles; and a third step of fine-tuning the re-trained language model through supervised learning using a third training dataset classified by domain.

Here, the first training dataset is a large corpus created regardless of the domain and the styles.

In the second step, the pre-trained language model may be re-trained through unsupervised learning.

The second training dataset may have a domain identical to a domain of the third training dataset.

The second training dataset may be different from the first training dataset but have a domain identical to a domain of the third training dataset.

In another embodiment of the present disclosure, there is disclosed a computing device and a recording medium for implementing the above-described training method.

According to the present disclosure, as a reading comprehension process requires understanding of style as well as text, style-based adaptive pre-training is applied to machine reading comprehension, enabling the language model to effectively perform machine reading comprehension by adaptively responding to different styles. In addition, unlike fine-tuning data that requires labeling, unlabeled data is additionally used in a pre-training step, resulting in time and cost-efficient outcomes.

Through the present disclosure, beyond conventional adaptive pre-training, which focuses on matching with fine-tuning data and domains, it is possible to matching with writing style, thereby promoting greater performance enhancement.

### BRIEF DESCRIPTION OF THE DRAWINGS

FIG. 1 is a flowchart for explaining a training method according to an embodiment of the present disclosure.

FIG. 2 is a diagram for explaining an experiment to determine the effect of adaptive pre-training.

FIG. 3 is a block diagram of a computing device according to an embodiment of the present disclosure.

### DESCRIPTION OF EXEMPLARY EMBODIMENTS

Hereinafter, embodiments of the present disclosure will be described in detail with reference to the drawings. In the following description and the accompanying drawings, however, well known techniques may not be described or illustrated in detail to avoid obscuring the subject matter of the present disclosure. In addition, throughout the specification, “including” a certain component does not mean excluding other components unless specifically stated to the contrary, but rather means that other components may be further included.

It will be understood that, although the terms first, second, etc. may be used herein to describe various elements, these elements should not be limited by these terms. These terms are used to distinguish one element from another. For example, a first element could be termed a second element, and a second element could be termed a first element, without departing from the scope of the present inventive concept.

Terms used in the present disclosure are only used to describe specific embodiments and are not intended to limit the present disclosure. As used herein, the singular forms “a”, “an,” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Labeled data used for fine-tuning a pre-trained language model takes a significant amount of time and cost for labeling. If a task is domain-specific, it is more difficult to obtain the data. Therefore, in the present disclosure, before fine-tuning a language model that has been pre-trained through unsupervised learning, the model is additionally re-trained to enhance fine-tuning performance. This adaptive pre-training involves further pre-training an unlabeled dataset, which is used for fine-tuning (task-) or has a similar domain as that of a fine-tuning dataset (domain-), so that the language model is adaptive to the fine-tuning data.

In addition, unlike English, which is a noun-centered language, verb-centered languages such as Korean uses special honorific vocabulary, sentence-ending particles, and auxiliary words that clearly reflect social relationships. Due to these characteristics, styles of verb-centered languages are distinguished based on a system of sentence-ending particles, rather than merely on levels of formality. Therefore, adaptive pre-training of a verb-centered languages model requires research from a stylistic perspective. Considering that a reading comprehension process requires understanding of texts, including style, the present disclosure relates to adaptive pre-training from a verb-centered language, for example, Korean stylistic point of view in machine reading comprehension (MRC).

Hereinafter, an embodiment of the present invention will be described in detail. The description of one embodiment below is aimed at Korean, but the present invention is not intended to be limited thereto, and of course can be equally applied to verb-centered languages that have linguistic characteristics similar to Korean.

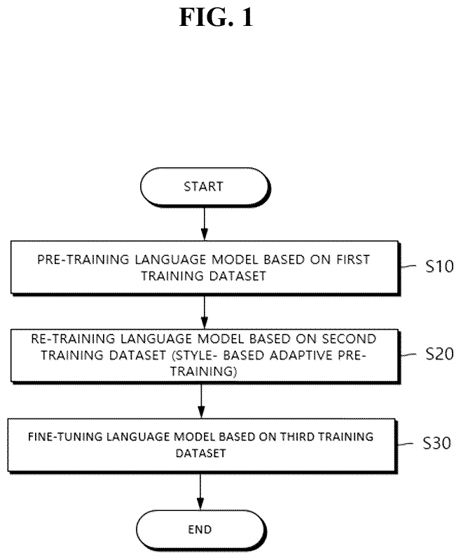

The training method according to an embodiment of the present disclosure proceeds through three steps to perform style-based adaptive pre-training. As shown in FIG. 1, the training method according to an embodiment of the present disclosure may include: a first step S10 of pre-training a language model through unsupervised learning; using a first training dataset a second step S20 of re-training the pre-trained language model using a second training dataset with distinguished styles; and a third step S30 of fine-tuning the re-trained language model through supervised learning using a third training dataset classified by domain.

Here, the first training dataset is a large corpus created regardless of the domain and the styles.

In the second step, the pre-trained language model may be re-trained through unsupervised learning.

The second training dataset may have a domain identical to a domain of the third training dataset.

The second training dataset may be different from the first training dataset but have a domain identical to a domain of the third training dataset.

The configuration of the present disclosure as described above may be more specifically understood through experiments and results thereof, as described below.

In the training method of the present disclosure, the first step uses a pre-trained language model. Since style-based adaptive pre-training is performed to reflect linguistic characteristics of Korean, a Korean language model is used. In the second step, the pre-trained language model is re-trained using data with the same style as that of data used for fine-tuning. In this case, unlabeled text data is used in the second step which corresponds to adaptive pre-training. In the third step, fine-tuning is performed on the re-trained language model using labeled datasets.

In one embodiment, three styles are used to conduct adaptive pre-training from a Korean stylistic point of view. The first style is the written style of administrative documents (hereinafter referred to as “administrative style”). The administrative documents must clearly and concisely express content with hierarchical spacing according to document writing rules, often using nominal endings and nouns. The second style is the written style of news articles (hereinafter referred to as “news style”). The news style uses declarative sentence endings forming declarative sentences. The third style is the colloquial style of video comments (hereinafter referred to as “online colloquial style”). The online colloquial style is composed of informal spoken language forms. Examples of the aforementioned styles are shown in Table 1.

TABLE 1

| Style | Example Sentence |
|---|---|
| Administrative | Although semiconductor exports decreased due to the |
| Style | base effect from last year's robust exports, the highest |
| | monthly performance of the year (5.7 billion USD) was |
| | achieved thanks to rising prices and increased demand. |
| | For displays, the decline was mitigated due to increased |
| | demand for OLEDs and the recovery of panel prices. |
| News Style | Since its opening in 2006, it has boasted the highest |
| | level of safety in the country with 15 years of accident- |
| | free operation. Last year, it was awarded the Minister of |
| | Public Administration and Security's Disaster |
| | Management Evaluation Award. |
| | This year, plans are underway to establish an “Artificial |
| | Intelligence (AI) Station,” befitting the reputation of the |
| | science city of Daejeon. |
| Online | Personally, worried about my computer cos the graphics |
| Colloquialism | have improved so much for the live-action adaptation. |
| | Given the circumstances, they need several unique AI |
| | characters in the Star Wars universe, so why not give it |
| | a shot? |

Hereafter, the practical effects of the training method according to an embodiment of the present disclosure will be experimented with and the experimental results will be explained.

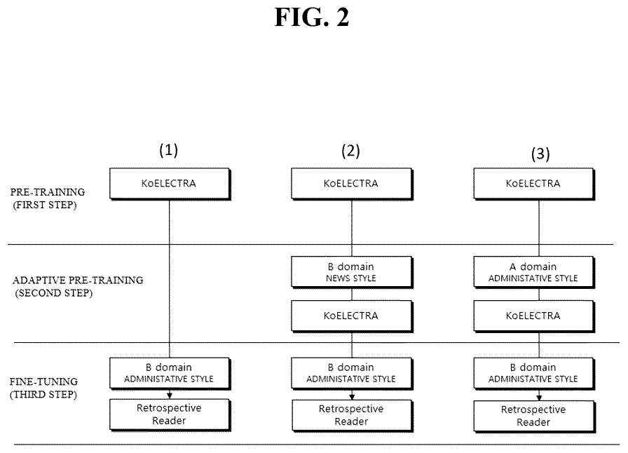

The adaptive pre-training used in the experiment, the experimental design, the datasets, and the models will be explained with reference to FIG. 2 as follows.

Adaptive Pre-Training from Stylistic Point of View (Second Step)

Existing machine reading comprehension involves fine-tuning the pre-trained Korean language model KoELECTRA, which is trained on news, Wikipedia, and Namuwiki data, with administrative style data using the machine reading comprehension model Retrospective Reader, as shown in (1) of FIG. 2.

In the style-based adaptive pre-training (second step), additional pre-training (or re-training) is conducted with data of the same style as that of data used for fine-tuning, as shown in (3) of FIG. 2. The fine-tuning data and domain are set differently to exclude the effect of the domain and verify the effect of style-based adaptive pre-training. (2) of FIG. 2 serves as a control group for (3) of FIG. 2, using different fine-tuning data and styles.

### Design of Experiment

To analyze the importance of style-based adaptive pre-training, the first experiment is conducted as shown in FIG. 2. To minimize domain influence and verify the effect of style-based adaptive pre-training, a domain capable of reducing domain specificity for each style is used as the B domain of FIG. 2. The administrative style uses a public administration domain as the B domain, and the news style used in (2) of FIG. 2 uses a mixture of four domains, including politics and economy. The A domain in (3) of FIG. 2 uses the science domain, which is different from the domain used in fine-tuning. In addition, the style-based adaptive pre-training is tested for each style. With the domain of the adaptive pre-training step (Second Step) being set as the science domain, the experiment is conducted on the administrative style, news style, and online colloquial style.

### Dataset

Administrative documents use machine reading comprehension data from AI HUB's administrative document dataset. In this data, science and public administration domains, are used, and the machine reading comprehension question types used for fine-tuning include an answer boundary extraction type, a procedural (method) type, and an unanswerable type. For the news style, IT and science domains of AI HUB's news article machine reading comprehension data are used. For the online colloquial style, science domains of AI HUB's online colloquial corpus data are used. A total of 32,976 question-answer pairs from administrative style data are used for fine-tuning in all experiments. The first experiment's adaptive pre-training utilizes 50,000 sentences each from news and administrative documents, and the second experiment's adaptive pre-training utilizes 5,000 sentences each from news and administrative documents, along with 9,000 sentences from the online colloquial style, taking sentence length into account.

### Language Model

KoELECTRA-small-v2 is used as the Korean pre-trained language model. To ensure that the administrative documents are excluded from pre-training, the version 2 of KoELECTRA which is pre-trained on approximately 14 GB of data from news, Wikipedia, and Namuwiki is utilized. The machine reading comprehension in this experiment utilizes a span extraction type, which finds the answer to a question within a paragraph, and an unanswerable question type, which determines whether a question can be answered or not. The machine reading comprehension model utilizes the Retrospective Reader. The Retro-Reader is a model that mimics human reading comprehension, showing the best performance when using the ELECTRA model. For performance evaluation, the Exact Match (EM) metric, assessing whether questions are answered accurately, and the F1 score, determining answer correctness on a token-by-token basis, are utilized.

The experimental results are as follows.

The results of the first experiment are shown in Table 2. Among the three experiments (1), (2), and (3) of FIG. 2), the experimental group (3) where style-based adaptive pre-training (Step 2) according to the present disclosure is applied shows the highest performance. Compared to the control group (2), it can be confirmed that style-based adaptive pre-training improves machine reading comprehension performance. In addition, compared to (1) where fine-tuning is conducted using labeled data according to a conventional technique, there is a significant performance difference, and thus, it can be confirmed that machine reading comprehension performance can be greatly improved using unlabeled data with similar styles.

TABLE 2

| | Experiment (Domain - Style) | | | |
|---|---|---|---|---|
| | Second Step | Third Step | EM | F1 |
| (1) | — | Public-administrative style | 63.32 | 73.07 |
| (2) | General - news style | Public-administrative style | 65.94 | 74.22 |
| (3) | Scientific-administrative | Public-administrative style | 70.67 | 76.80 |
| | style | | | |

The result of the second experiment, where adaptive pre-training (second step) is performed on each style, are shown in Table 3. The adaptive pre-training in (3) of Table 3, which matches fine-tuning data and the style, shows the best performance. In addition, adaptive pre-training for online colloquial style of (1) shows lower performance than that of news style of (2). Considering that both the news and administrative styles are written styles, the performance of adaptive pre-training may significantly differ depending on the similarity between Korean language styles.

TABLE 3

| | Experiment (Domain - Style) | | | |
|---|---|---|---|---|
| | Second Step | Third Step | EM | F1 |
| (1) | Science-colloquial style | Public-administrative style | 51.20 | 61.86 |
| (2) | Science-news style | Public-administrative style | 65.03 | 74.02 |
| (3) | Scientific-administrative | Public-administrative style | 66.30 | 75.69 |
| | style | | | |

In the present disclosure, style-based adaptive pre-training is conducted in machine reading comprehension, considering linguistic characteristics of Korean. Significant performance improvement is observed in an experiment where data with the same style as that of machine reading comprehension data are additionally pre-trained. This indicates that style-based adaptive pre-training improves the performance of a language model.

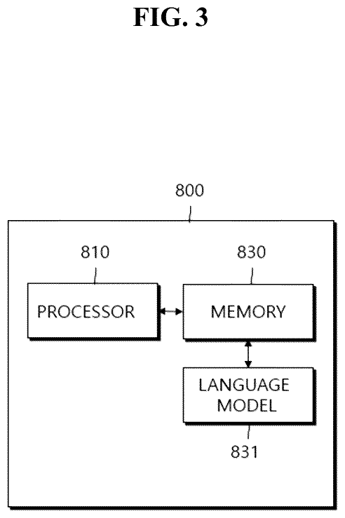

FIG. 3 is a block diagram of a computing device for training a language model with adaptive pre-training applied, reorganizing the aforementioned configurations from a hardware perspective. Hence, only a brief overview of each configuration's function and operation will be herein provided to prevent redundancy in the explanation.

A computing device 800 includes a memory 830 storing a language model 831 for machine reading comprehension, and a processor 810 for executing the language model to infer results from inputs.

The language model 831 is pre-trained using a first training dataset through unsupervised learning, re-trained using a second training dataset with distinguished styles through unsupervised learning, and then fine-tuned using a third training dataset classified by domain through supervised learning.

The first training dataset may be a large corpus created regardless of a domain and style.

The second training dataset may have the same domain as that of the third training dataset, or may be different from the first training dataset and have the same domain as that of the third training dataset.

Meanwhile, the present disclosure may be implemented as computer readable codes on a computer-readable recording medium. The computer-readable recording medium may be any data storage device that may store data which may be thereafter read by a computer system.

Examples of the computer-readable recording medium include read only memory (ROM), random access memory (RAM), compact disk-read only memory (CD-ROM), magnetic tapes, floppy disks, optical data storage devices, etc. The computer-readable recording medium may also be distributed over network-coupled computer systems so that the computer-readable code may be stored and executed in a distributed fashion. Also, functional programs, codes, and code segments for accomplishing the present disclosure may be easily construed by programmers skilled in the art to which the present disclosure pertains.

In the above, various embodiments of the present disclosure have been described. It will be understood by one of ordinary skill in the art that various changes in form and details may be made therein without departing from the scope of the disclosure as defined by the following claims. Therefore, the embodiments should be considered in a descriptive sense only and not for purposes of limitation. The scope of the present disclosure is defined not by the detailed description of the disclosure but by the following claims, and all differences within the scope will be construed as being included in the present disclosure.

What is claimed is:

1. A method of training a language model from a stylistic perspective, the method comprising:
a first step of pre-training a language model using an unsupervised training method using a first training dataset;
a second step of re-training the pre-trained language model using a second training dataset with distinguished styles; and
a third step of fine-tuning the re-trained language model using a third training dataset classified by domain through supervised learning.

2. The method of claim 1, wherein the first training dataset is a large corpus created regardless of the domain and the styles.

3. The method of claim 1, wherein in the second step, the pre-trained language model is re-trained through unsupervised learning.

4. The method of claim 1, wherein the second training dataset has a domain identical to a domain of the third training dataset.

5. The method of claim 1, wherein the second training dataset is a dataset different from the first training dataset and has a domain identical to a domain of the third training dataset.

6. A non-transitory computer-readable recording medium in which a program for causing a computer to execute the method according to claim 1.

7. A computing device comprising:
a memory configured to store a language model for machine reading comprehension; and
a processor configured to execute the language model and infers a result from an input,
wherein the language model is pre-trained using a first training dataset through unsupervised learning, re-trained using a second training dataset with distinguished styles through unsupervised learning, and fine-tuned using a third training dataset classified by domain through supervised learning.

8. The computing device of claim 7, wherein the first training dataset is a large corpus created regardless of the domain and the styles.

9. The computing device of claim 7, wherein the second training dataset has a domain identical to a domain of the third training dataset.

10. The computing device of claim 7, wherein the second training dataset is a dataset different from the first training dataset and has a domain identical to a domain of the third training dataset.
